(19) United States
(12) Patent Application Publication
(10) Pub. No.: US 2011/0179571 A1
(43) Pub. Date: Jul. 28, 2011

(54) Therapeutic medical toilet bed

(76) Inventor: Sherrie Clayton, Bakersfield, CA (US)

(21) Appl. No.: 12/657,578

(22) Filed: Jan. 25, 2010

(51) Int. Cl. A61G 7/02

(52) U.S. Cl. 5/605

(57) ABSTRACT

The therapeutic medical toilet bed includes an integrally formed center base mattress with hydraulic retraction system fully supported on a mattress frame unit capable of adapting to any standard medical bed frame. The therapeutic mattress can adapt to multiple positions to secure a position as required for patient care and comfort. The fully functional toilet system can be utilized by retracting the center base mattress by a remote controlled hydraulic system as needed by patient. Also included with toilet system is a pressurized water system with sanitizing unit for cleansing, sanitizing and flushing of waste products downwardly into a high capacity storage container with sanitizing unit.

### BACKGROUND OF THE INVENTION

1. Field of Invention

The present invention relates to the art of therapeutic bedding and to the particular field of therapeutic medical beds used in the health care system.

2. Description of Related Art

It is generally the practice for bed-ridden patients to often encounter problems. If the patient is bed-ridden for a long period of time and soils the mattress the bed has to be changed. If the patient is unable to attend to his or her self a soiled mattress may go unchanged. This is especially so if the mattress has to be replaced. This is not only an inconvenience for the patient but also for the health care staff or person taking care of patient.

Those patients who are bed-ridden and have to use a bed pan usually have to be assisted by someone capable of lifting the patient. This may be difficult for the caregiver, and uncomfortable and inconvenient for the patient.

Typical medical beds having toilet systems designed into the bed have certain limitations in order to allow the patient to utilize the toilet without leaving the bed. Some designs require the caregiver to move the patient to one side of the bed while the toilet system is placed in position prior to use. Other designs require the patient to be temporarily suspended between the openings while waiting for the toilet to be placed into position for use.

Other similar medical toilet bed designs include complex bulky hydraulic systems that are noisy and vibrate while toilet is being placed into position for use. They may also place the patient into uncomfortable positions while waiting for the toilet to be placed into position possibly causing accidents or injury.

Improvements in medical beds to alleviate their limitations or increase their utility include designs for patient care and comfort and not problems that bed-ridden patients may encounter while attempting to use the toilet.

Therefore, it would be beneficial to provide a therapeutic medical toilet bed that can adapt to any standard medical bed and accommodate a toilet system with a simplistic hydraulic system integrally designed into a medical mattress in a manner that is comfortable and dignified for the patient and efficient for the health care system.

3. Summary of the Invention

The therapeutic medical toilet bed of this invention is an integral designed toilet system formed within a medical mattress and framed unit that is capable of adapting to standard medical beds. The medical mattress and frame unit is capable of adapting to secure a position with a simplistic quiet hydraulic system in order for a patient to utilize the toilet system in a manner that is comfortable and dignified for the patient without ever leaving the bed. The toilet system includes a fully functional toilet system comprising a stainless steel containment bowl capable of cleansing, sanitizing, and flushing waste downwardly into waste container after use. The therapeutic medical toilet bed of this invention further includes a removable waste container for collection of waste material and a pressurized water supply container for supplying water on demand and a sanitizer for disinfecting waste material.

Other advantages and features of the therapeutic medical toilet bed of this invention will be more fully understood from the following description of the preferred embodiments, the appended claims and the drawings, and a brief description of which follows.

### BRIEF DESCRIPTION OF DRAWINGS

FIG. 1 is a plan view of the therapeutic medical toilet bed in closed position of this invention.

FIG. 2 is a plan view of the therapeutic medical toilet bed in retracted position of this invention.

FIG. 3 is a longitudinal sectional view of the therapeutic medical toilet bed in retracted position of this invention.

FIG. 4 is a longitudinal sectional view of the therapeutic medical toilet bed in closed position of this invention.

FIG. 5 is a sectional view of the therapeutic medical toilet bed in retracted position of this invention.

FIG. 6 is a sectional view of the therapeutic medical toilet bed in closed position of this invention.

FIG. 7 is an isometric view of the therapeutic medical toilet bed in retracted position of this invention.

### DETAILED DESCRIPTION OF A PREFERRED EMBODIMENT

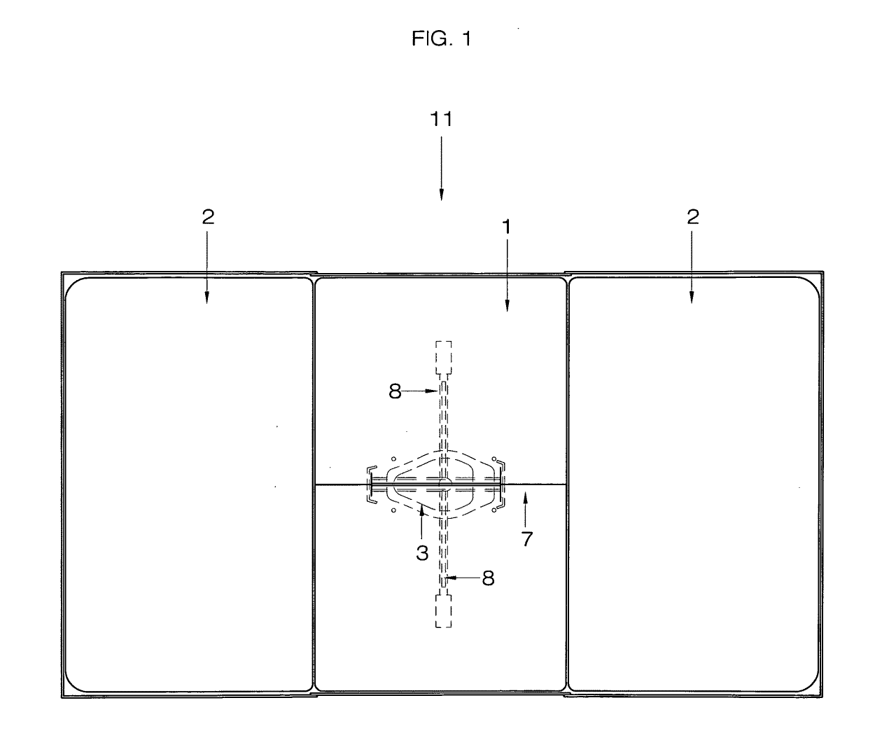

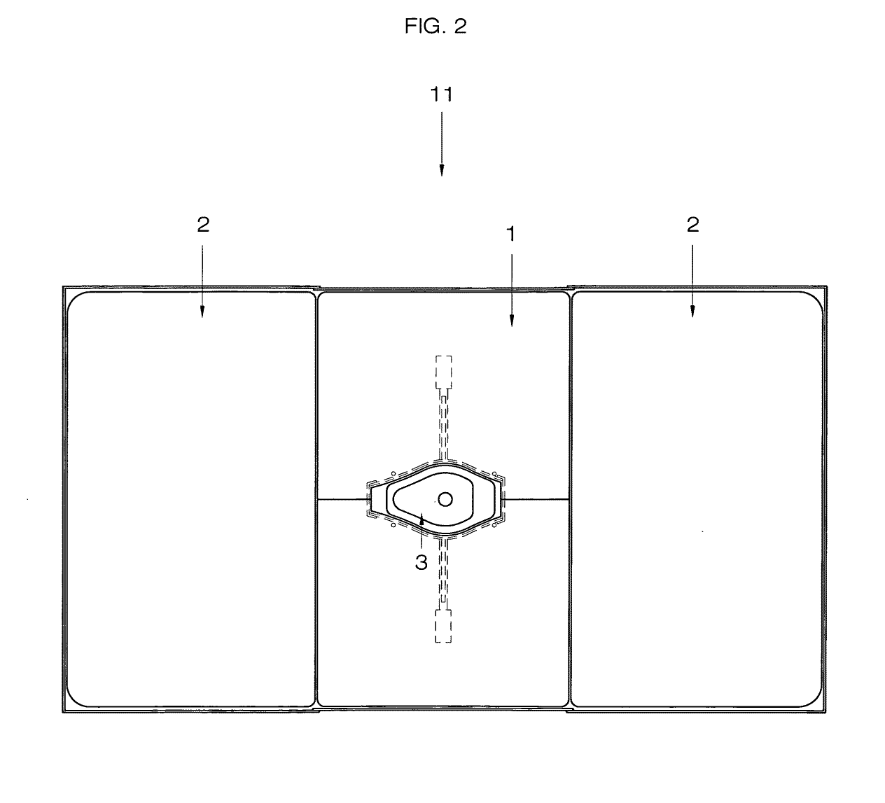

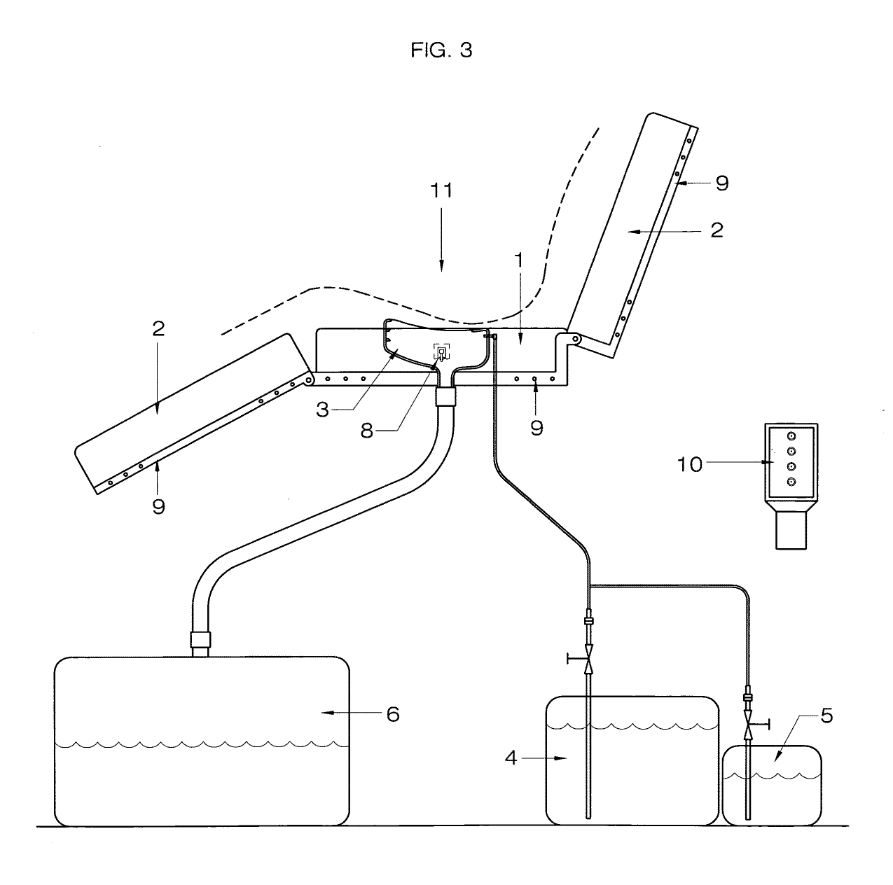

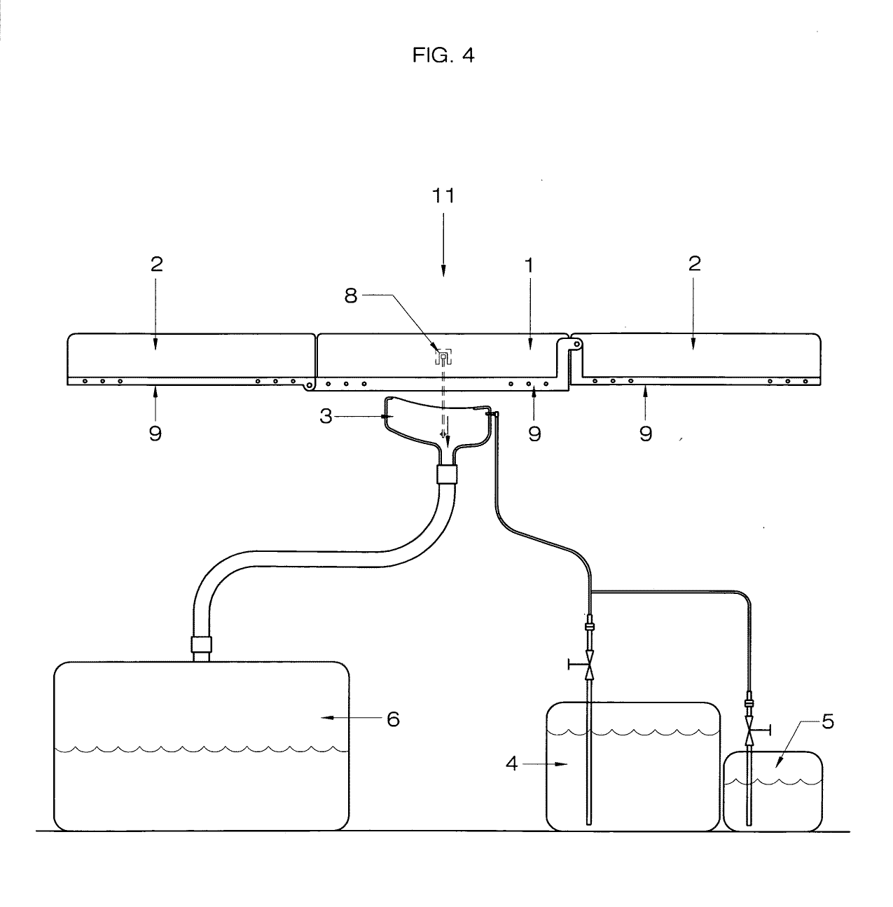

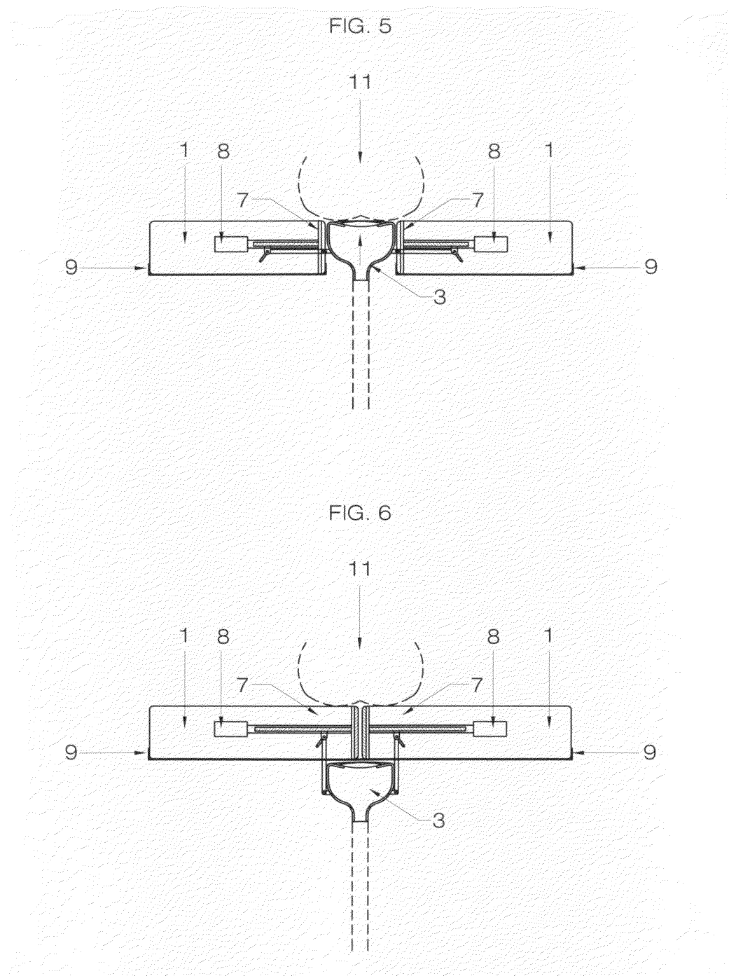

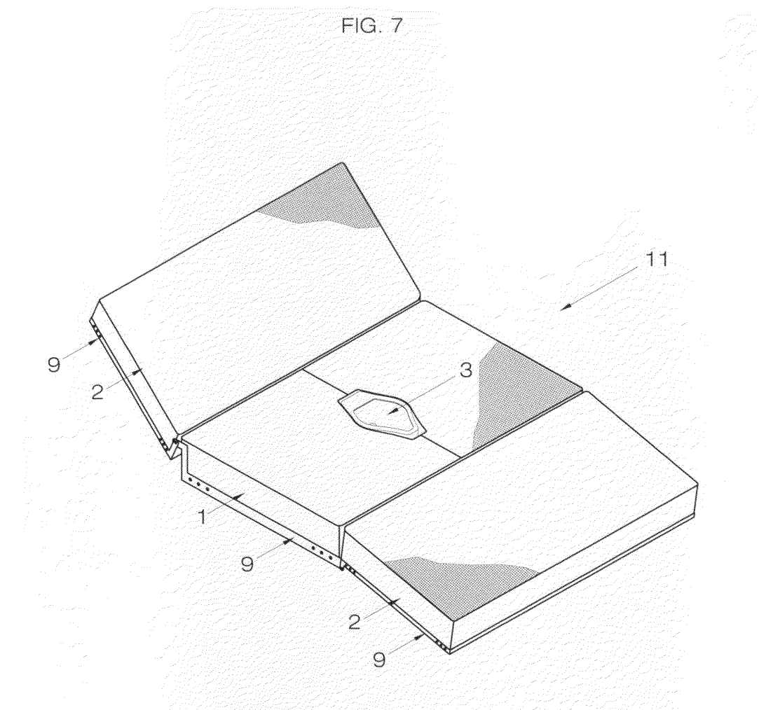

The details of the preferred embodiment of an integral single inventive concept of the therapeutic medical toilet bed 11 shown in FIG. 1 which include a fully functional toilet system as described below. The toilet system comprising a stainless steel containment bowl 3 with pressurized water flush system 4 for cleansing patient and sweeping and discharging of waste products downwardly on demand by remote control box 10. The toilet system further includes a pressurized portable water supply tank 4 with urological deodorizer 5 and a high capacity portable waste container 6 with liquid disinfectant enabling a temporary storage of waste products flushed from toilet system 3. The plastic lined therapeutic medical mattress 2 and plastic lined center base mattress 1 with mattress frame unit 9 as shown in FIG. 3, FIG. 4, FIG. 5, FIG. 6, and FIG. 7 is capable of adapting to multiple positions on demand for patient care and comfort from remote control box 10. Said mattress frame unit 9 is also capable of adapting to any standard medical bed frame unit. Center base mattress 2 includes an integral formed retraction system compressing center base mattress 2 in retraction area away from center line of mattress forming an opening for stainless steel toilet 3 to be lifted into position by hydraulic system 8 when in use by patient as shown in FIG. 2, FIG. 3, FIG. 5, and FIG. 7

Having described the preferred embodiments of the therapeutic medical toilet bed of this invention, it will be understand that various modifications may be made to the therapeutic medical toilet bed of this invention within the purview of the appended claims. For example, as described above, the compatibility of the bed frame unit with existing medical bed frames according to their assembly. Furthermore, various configurations of the integral toilet system and center base mattress retraction system may vary from the description above. Having described these preferred embodiments of the therapeutic medical toilet bed of this invention, the invention is now claimed as follows.

I claim:

1. A therapeutic medical toilet comprising an adjustable vertical back, a horizontal seat and leg support, which includes a removable toilet containment system.

2. A therapeutic medical toilet bed as defined in claim 1, comprising a toilet seat formed for patient comfort.

3. The therapeutic medical toilet bed as defined in claim 1, comprises a removable toilet containment area for discharging of human waste products.

4-7. (canceled)

8. A therapeutic medical toilet bed as defined in claim 1, comprises a mattress with adjustable vertical back, horizontal seat and leg support.

9-11. (canceled)
